(19) United States
(12) Patent Application Publication
(10) Pub. No.: US 2012/0130881 A1
(43) Pub. Date: May 24, 2012

(54) Social Network for Traders of Stocks and Other Securities

(76) Inventor: Kuo Chiang, Pittsburgh, PA (US)

(21) Appl. No.: 12/954,571

(22) Filed: Nov. 24, 2010

(51) Int. Cl. G06Q 40/00

(52) U.S. Cl. 705/37

(57) ABSTRACT

A database may be used to aggregate indications of user intent to purchase or sell financial securities. This database may be accessed using mobile devices or client computers to thereby input user intent to purchase or sell financial securities. These inputs may be aggregated into the database. Users may be provided with the opportunity to purchase or sell in conformity with his or her intent indications. The intent indications may be verified by confirming that the user actually purchases or sells the financial security in conformity with his or her intent indication. This aggregate data may be accessed by users in order to query the user intent to purchase or sell securities ahead of their own actual purchases or sales. The data may then be reviewed by other users to aid in decisions whether to purchase or sell a financial security.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to a social network for traders of stocks and other securities.

2. Description of the Related Art

Using online social networks, users can quickly share information with one another and many individuals simultaneously. This information has primarily taken the form of direct textual input, photographs, videos and the sharing of already-available web content. To date, social networks have provided little relevant information specific to financial markets.

Simultaneously, financial tools have increasingly provided a greater functionality and accessibility to individual resources and the ways in which those resources may be allocated. However, these types of tools have failed to provide guidance pertaining to aggregate user intent to purchase or sell a given financial security before those users take action. These tools provide no such forward-looking guidance whatsoever. Traditionally, financial tools provide backward-looking data pertaining to the purchase and sale of securities and the way in which that influences securities prices.

### DESCRIPTION OF THE DRAWINGS

FIG. 1 is a diagram of a computer network.

FIG. 2 is a block diagram of a computing device.

FIG. 3 is a block diagram of a social network.

FIG. 4 is a data structure for the financial security data entries in an intent indication database.

FIG. 5 is a data structure for the users of the intent indication database.

FIG. 6 is a flowchart of user indication of intent.

FIG. 7 is a flowchart of intent indication review.

FIG. 8 is a flowchart of new user acceptance.

FIG. 9 is a flowchart of server intent indication acceptance.

FIG. 10 is a flowchart of API access.

Throughout this description, elements appearing in figures are assigned three-digit reference designators, where the most significant digit is the figure number and the two least significant digits are specific to the element. An element that is not described in conjunction with a figure may be presumed to have the same characteristics and function as a previously-described element having a reference designator with the same least significant digits.

### DETAILED DESCRIPTION

Description of Apparatus

A social network may be used to aggregate indications of user intent to purchase or sell financial securities into a database. This social network may be accessed using mobile devices or client computers to thereby input user intent to purchase or sell financial securities. These inputs may be aggregated into the database. Statistical data and other information regarding the intent indications and their correlation to actual security price fluctuations may be created and maintained for review by others involved in the social network. Throughout the present application, user input indication of an imminent intent to purchase or sell a financial security may be referred to as an “intent indication.” A purchase or sale may be generically described as a “trade” of a security.

Users may be provided with the opportunity to purchase or sell in conformity with his or her intent indications or those of others. The intent indications may be verified by confirming that the user actually purchases or sells the financial security in conformity with his or her intent indication. This aggregate data may be accessed by users in order to query the user intent to purchase or sell securities ahead of their own actual purchases or sales. The data may then be reviewed by other users to aid in decisions whether to purchase or sell a financial security. Users of the social network may request and review individual or aggregate intent indication data and statistics derived from this data prior to trades.

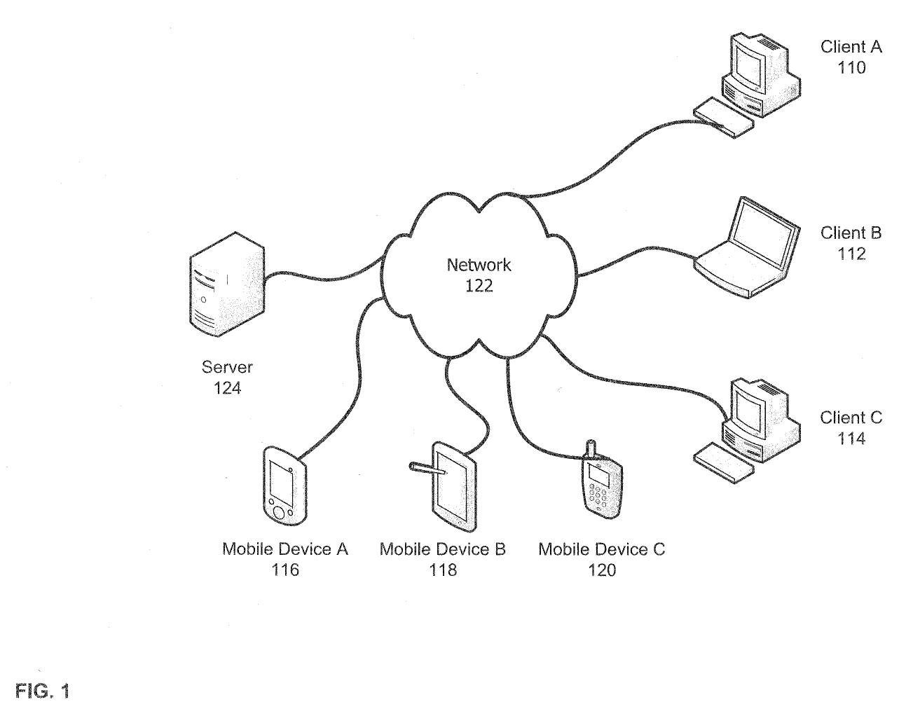

Referring now to FIG. 1, a computer network is shown. The computer network includes client A 110, client B 112 and client C 114. In addition to the clients A, B C, 110, 112 and 114, respectively, the network includes mobile device A 116, mobile device B118 and mobile device C 120. These mobile devices may be smart phones, cellular telephones, tablet PCs or other portable computing devices.

The clients and mobile devices may interact with one another via the network 122. The network 122 may take the form of a local network, a wide area network, the Internet or any number of other networks. The computer network described may be implemented on a network 122 that is closed to only a select group of users or may accept input and queries from all internet users seeking to add or to review information. In the case of a closed network, the network 122 limit access to a particular group of users such as individuals in a business, a financial institution, members of a local or peer-to-peer network or other group. The network 122 also includes a server 124 upon which many of the functions described herein may be implemented.

The clients A, B, and C, 110, 112, and 114, respectively, and the mobile devices A, B and C, 116, 118 and 120, respectively, interact with the server 124 using the network 122 to thereby generate content stored on the server 124. This content may be provided to the clients A, B, and C, 110, 112, and 114, respectively, 110, 112 and 114 and the mobile devices A, B and C, 116, 118 and 120, respectively. The content may be provided by means of a web server on the server 124 that accesses a database or a stand-alone software program operating on any of those devices that accesses the database on the server 124.

Each of the clients A, B, and C, 110, 112, and 114, respectively, are representative of a plurality of clients. The computer network described herein may be accessed by any number of individuals using any number of clients. Similarly, the mobile devices A, B and C, 116, 118 and 120, respectively, are representative of a plurality of mobile devices. These mobile devices A, B and C, 116, 118 and 120, respectively, may also be used by the same individuals as the clients A, B, and C, 110, 112, and 114, respectively, in order to access the server 124 when the user is away from his or her home computer. In other cases, the mobile devices A, B and C, 116, 118 and 120, respectively, may be the only way in which a user accesses the server 124.

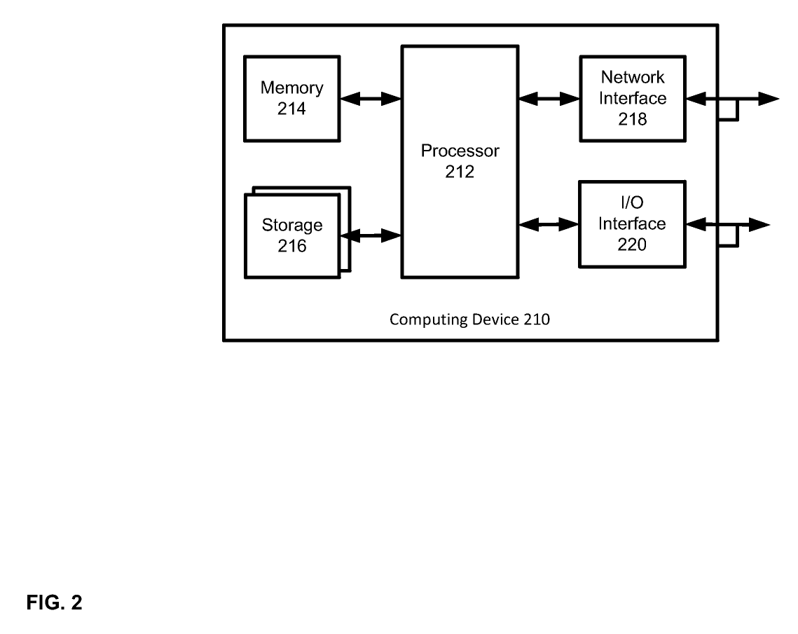

Turning now to FIG. 2, a computing device 210 is shown. The computing device 210 is intended to be representative of a multifunction computer such as the clients A, B, and C, 110, 112, and 114, respectively, or the server 124 in FIG. 1. However, the computing device 210 is also intended to include the mobile devices A, B and C, 116, 118 and 120, respectively. The server 124 may also be computing devices such as computing device 210.

The computing device 210 includes a processor 212. The processor 212 may be a single processor, a group of processor cores operating in concert with one another or a group of interconnected processors operating as a distributed processor through the use of distributed computing hardware or software. The computing device 210 also includes memory 214 that may take the form of read-only memory (ROM) or random access memory (RAM) or both in combination. Various forms of both types of memory are well-known.

The computing device 210 also includes storage 216 that may be a hard disk drive, a solid-state drive, a CD-ROM or DVD drive, a high-capacity non-volatile memory, a network storage device such as so-called “cloud” storage or other relatively high-capacity forms of storage. This storage 216 may be a single drive or may be a number of storage units, each connected to the processor 212 either with a bus or via a network.

The computing device 210 also includes a network interface 218. This network interface may be a wired network such as Ethernet or token ring network and may include access to local networks, a wide-area network and the Internet. The network interface 218 may also be a wireless interface such as access to a WiFi internet or network access point or data access via a wireless telephone network. The network interface 218 is intended to include any access to any network of more than one computing device 210.

The computing device 210 also includes an input/output interface 220. This input/output interface 220 is representative of wired or wireless input and output to various devices. These may include VGA, DVI or DisplayPort output to computer monitors or to displays attached to a mobile device. These may also include input and output means associated with computer mice, keyboards, speaker systems, kinetic feedback, microphones, touchscreens and other input and output devices.

The methods of the present application may be implemented through instructions stored in storage 216, loaded into memory 214 and executed by the processor 212. In responding to requests from users, or in users making requests depending upon the particular computing device 210 being used, the processor may utilize the network interface 218 or the input/output interface 220 to communicate with users, the server or various peripherals.

A computing device 210 may include software and/or hardware for providing functionality and features described herein. A computing device 210 may therefore include one or more of: logic arrays, memories, analog circuits, digital circuits, software, firmware, and processors such as microprocessors, field programmable gate arrays (FPGAs), application specific integrated circuits (ASICs), programmable logic devices (PLDs) and programmable logic arrays (PLAs). The hardware and firmware components of the computing device 210 may include various specialized units, circuits, software and interfaces for providing the functionality and features described here. The processes, functionality and features may be embodied in whole or in part in software which operates on a computing device 210 and may be in the form of firmware, an application program, an applet (e.g., a Java applet), a browser plug-in, a COM object, a dynamic linked library (DLL), a script, one or more subroutines, or an operating system component or service. The hardware and software and their functions may be distributed such that some components are performed by one computing device 210 and others by other devices.

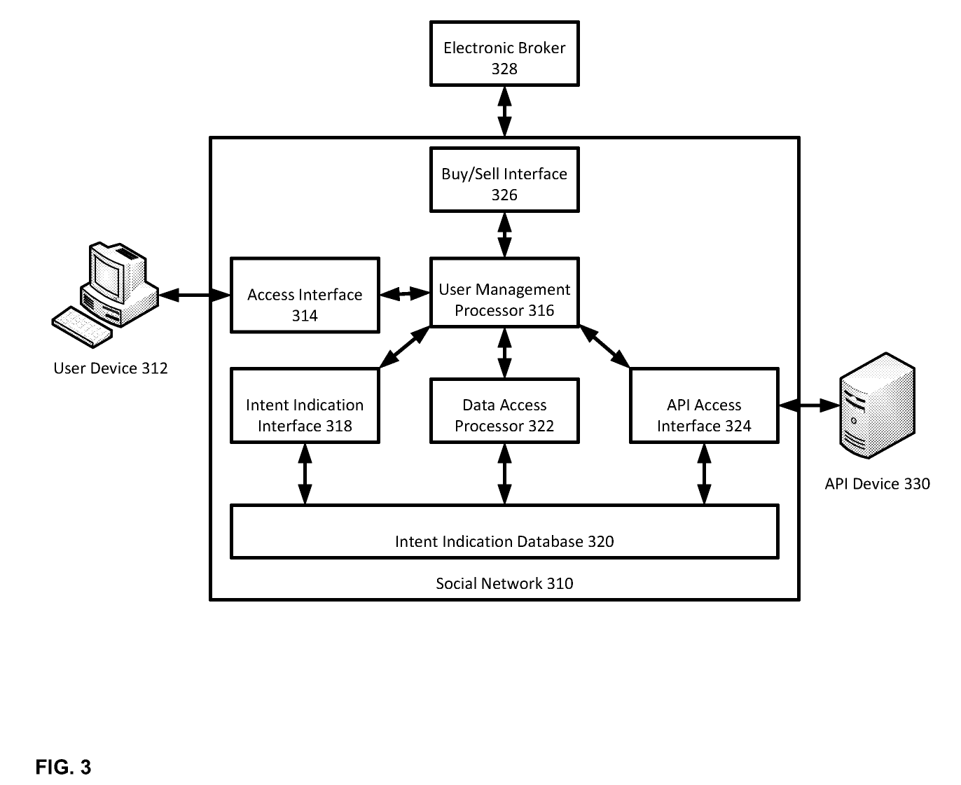

Turning now to FIG. 3, a block diagram of a social network 310 is shown. The social network 310 may take a number of forms. Each of the elements shown in FIG. 3 and described below as making up a portion of the social network 310 may be integrated within other components or may, themselves, integrate other components. The social network 310 is intended to be representative of one way in which the system and methods of the present application may be implemented.

The social network 310 may be implemented in part as software and hardware working in concert on a server 124 to provide the functionalities described below to client computers, mobile devices, API devices and electronic brokers. The social network 310 is shown as including certain elements and excluding others. However, each of the elements presented that interacts with the social network 310 may be considered a part of the social network 310.

The first element of the social network 310 is a user device 312. As with other networks, the social network 310 is increasingly useful as more individuals are added. Accordingly, the user device 312 is representative of a multiplicity of client computers and mobile devices which access the social network 310. The user device 312 may include software specifically designed to interact with the social network 310. Alternatively, the user device 312 may have access to an internet or intranet website that enables access to the social network 310 without the use of client-side software other than a web browser or similar software.

The user device 312 interacts with the social network 310 via an access interface 314. This access interface 314 may be a series of web pages designed to enable user access to the social network 310. The access interface 314 may be server software designed to interact with client software resident on the user device 312. The access interface 314 enables a potential user to sign up to use the social network and assigns a user identification to that user. The access interface 314 may accept additional information regarding the user during the registration process.

In subsequent user access, the access interface 314 may accept the user identification and, if necessary, a password or other secure login form. Alternatively, other unique identification may be used such as a phone number associated with a mobile device or other mobile device unique identification. The access interface 314 operates as a go between for the user device 312 and the user management processor 316.

The access interface 314 is also designed to ensure that a single user's interactions are not duplicated as he or she interacts with the social network 310. A single user may only be associated with one intent to buy or sell a financial security at a given time. This ensures the accuracy of the data in the database and that the data is relevant for individuals seeking accurate representations of aggregate individual opinion or intent. In so doing, the access interface 314 may utilize unique identification such as the username or may also use MAC addresses, IP addresses or, in some cases, specific user identification information that must be entered at login in order to ensure that a single individual is using the social network 310. The access interface 314 may also use unique identification associated with a mobile device such as network ID, device ID or phone number. The access interface 314 helps to ensure the accuracy of the information available to users of the social network 310.

The user management processor 316 enables users to input purchase or sale intent indications using the intent indication interface 318, to request and view data stored in the database using the data access interface 322 or to provide API access to input or to the data using the API access interface 324. The user management processor 316 receives information from users and directs the information to the intent indication interface 318 so that it may be integrated with the intent indication database 320. The user management processor 316 and intent indication interface 318 also work together to create statistics related to the user intent indications that may be integrated into the intent indication database 320. The user management processor 316 also directs user inquiries to the intent indication database 320 through the data access interface 322. In this way, the user management processor 316 acts to direct input or output as it is given by or provided to the various users.

The intent indication interface 318 is designed to provide a means by which a user may input his or her intent to purchase or to sell a given financial security into the intent indication database 320. The intent indication interface 318 may be implemented as an aspect of a web page or group of web pages. These web pages provide an interface whereby a user can select a particular financial security by name, ticker symbol or other identifier. Once selected, a user may indicate an intent to purchase or to sell the financial security using the intent indication interface. This indication may simply require a mouse click or may require a user to reenter his or her login credentials in order to confirm input of the purchase or sale intent. The intent indication interface 318 may also take the form of a stand-alone software program or an aspect of another web page, web-based application or software program.

In conjunction with the access interface 314, the intent indication interface 318 ensures that a single use's most recent intent indication is the only one currently displayed to viewers of the intent indication database 320. For example, a user may input a buy or sell indication any number of times over a given period, but only the most recent will be currently stored in the database 320. Preferably, the intent indication database 320 shows, by default, a single purchase or sale intent indication at a time. However, a historical record of prior intent indications are also stored and may be viewed by security or by user by other users. Because the intent indication interface 318 ensures that a user cannot input multiple purchase intents, the data in the intent indication database in aggregate will accurately reflect the actual intent of the users of the social network 310 at any given moment. In addition, the data will always reflect the user's most recent intent.

The intent indication interface 318 may also accept comments submitted in conjunction with the user's intent indication. For example, a user may make an intent indication of a purchase of a financial security. Simultaneously, the user may submit, via a web page interface or software on the user's user device 312, a comment such as “The company just announced an amazing new product!” These comments may be useful in providing additional information regarding the reasons for the user's intent indication. These comments may be moderated by known systems and methods in order to ensure that the comments are used appropriately.

The intent indication interface 318 may also accept general comments pertaining to a financial security from users. That is, users not inputting an intent indication may be able to add comments regarding the financial security like the example comment provided above. Subsequent users who review the intent indication database and in particular, the database entry or entries associated with the financial security, may be able to peruse the comments both on the individual intent indications and those on the financial security in general. These comments in both cases may provide additional guidance to a user of this social network 310.

The user management processor 316 also directs users to the data access interface 322 when they may requests for information. The data access interface may be used to access data in the intent indication database 320. This data includes aggregate buy and sell intent indications for each financial security in the intent indication database 320 along with any comments made by users of the social network 310 regarding their respective buy and sell intent indications. The intent indication database 320 also includes any general comments on the financial security. The intent indication database 320 may also include financial information pertaining to the financial security, those individuals who are most often or most recently indicating their intent to sell the financial security and a security profile. Aggregate data pertaining to a user or to a security may be accessed as well. All of this information may be accessed by a user of the social network using the data access interface 322.

The user management processor 316 also interacts with the API access interface 324 to provide access to API devices such as the API device 330. An API device 330 may be a third party service, website or other connected device that seeks to access the information in the intent indication database 320 without resort to the access interface 314. One example of such an API device 330 is a third party website that utilizes the aggregate intent indications in the intent indication database to provide aggregate intent indication information on a particular security or group of securities to its users. The operator of the social network 310 may charge for this access. Alternatively, the API device 330 may be a server associated with a third party that inputs user intent indications en masse and, therefore, requires more direct access to the intent indication database 320. These API devices are provided more direct access to the intent indication database 320 so that its data may be augmented or used by others. The API access interface 324 provides the system and methods needed for access.

The API access interface is designed to accept an API key whereby a third party who has such an API key may be provided with more direct access to the intent indication database 320. When in possession of an API key, the API device 330 may use the API access interface 324 to directly interact with the intent indication database 320. The API access interface 324 responds to data input in a form suitable for input or in a form very nearly suitable for addition directly to the intent indication database 320. Similarly, the API access interface 324 responds to commands that are in a form suitable for immediate execution. Such commands can be requests for the intent indication database 320 entries associated with one or more financial securities. These requests can then be delivered to the API device 330 in a form very similar to that in which they are stored on the intent indication database 320.

The buy/sell interface 326 is another component accessible to the user management processor 316. The buy/sell interface 326 may be implemented in a manner similar to that of the API access interface 324, but it provides access to electronic broker 328 functions. In particular, the user of the user management processor 316 may access the buy/sell interface 326 to thereby act upon his or her wishes after reviewing the content of the intent indication database 320.

The buy/sell interface 326 may operate in a manner such that after a user has made an indication of intent to buy or purchase a security using the intent indication interface 318 or has viewed aggregate data pertaining to users intent using the data access interface 322, the user may then be presented with the option of buying or purchasing that security. The user may then use the buy/sell interface 326 to request that an electronic broker 328 execute the purchase or sale of the security, either immediately or at a predetermined time. In this way, the social network 310 may operate to enable a user to fulfill his or her intentions immediately after or within a short time of making them known.

The electronic broker 328 may operate in response to requests from the buy/sell interface 326 to purchase or sell securities according to user desires. The buy/sell interface may be provided access to a user's login and password or other credentials necessary to access that user's accounts and to execute trades of securities. Using these credentials, the buy/sell interface 326 may request that the electronic broker 328 execute those trades. The electronic broker 328 is shown here as a single element, but it is intended to be representative of a number of electronic brokers that may be accessed by a user using the buy/sell interface 326.

In some implementations, an electronic broker 328 account associated with a particular user may be required before a user is permitted to register for the system. In this way, the social network can ensure that a user actually follows through with his or her intent to buy or sell a financial security after indicating that he or she intends to do so. Alternatively, a high correlation between intent indications and actual actions may be required, but not 100% correlation.

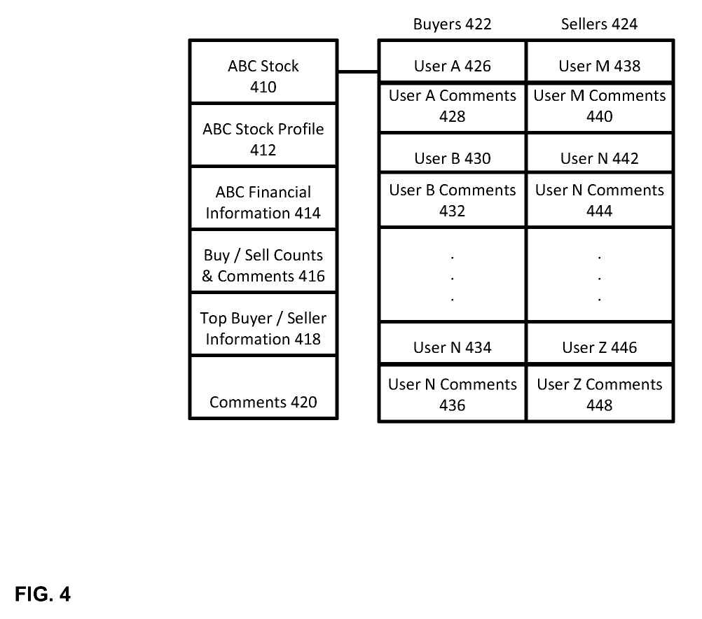

Turning now to FIG. 4, a data structure for the financial security data entries in an intent indication database is shown. The data structure is shown as including several elements, but it may include fewer or more elements as a part of the structure. These elements are merely shown as an example of the types of data that may be stored. Each of these elements are described below.

The first is an identifier of the security itself such as ABC stock 410. This is merely an identifier of the security to which the record pertains. This may include merely the security name, but may also include a unique identifier used by the social network and associated with that security. The next element is an ABC stock profile 412. The ABC stock profile is a profile of the security itself. The types of information stored in this profile may include historical prices for the security, a trading volume history, information pertaining to the company represented by the security, analyst reports pertaining to the security and other, similar information. This information may be relevant or useful to an individual reviewing the intent indication database 320 or making an intent indication.

The ABC financial information 414 is a financial profile of the security that is provided in conjunction with each of the securities in the intent indication database. This profile may include access to balance sheets, cash flow statements, income statements and similar financial spreadsheets related to the ABC stock 410 or the company, companies, indexes, options or other holdings represented by the stock. This type of information may be relevant or useful to an individual reviewing the intent indication database 320 or making an intent indication.

The buy/sell counts & comments 416 are the counts of the number of users who have made an intent indication that they are buying or selling the identified security. These counts are the aggregate counts of each individual within a specified time-frame who has indicated an intent to buy or sell. The time-frame maybe a single day, two days, three days or over the course of a longer period of time. A user may designate a particular day in the past or period of time in the past to review and for which to view any charts or graphs associated therewith. The buy/sell counts & comments 416 include any comments made by the user related to a particular buy or sale intent indication.

In addition, the buy/sell counts and comments 416 may be aggregated by the intent indication database such that dynamically generated lists of the securities with the most buy intent indications and those with the most sell intent indications are maintained. In addition, statistics such as correlation coefficients related to the historical accuracy of these intent indications for individual users and in aggregate may be created. Statistics regarding the way in which the number of intent indications to buy or to sell a security coincide with various levels of price fluctuation for the security may also be created. Over time, individual users with particularly high accuracy may be sought out by other users for their intent indications on whether to buy or sell certain securities. Similarly, securities that perform according to the historical intent indications of an individual or in aggregate may be identified by these statistics. Historical data for the intent indications of a particular user and in aggregate are also retained.

In addition, the buy/sell counts and comments 416 may include the most popular security. This is the security with the most, current intent indications of either type. For example, if one security has 50 buy indications and 45 sell indications while another security has 35 buy indications and 35 sell indications, the first security is more popular than the second. Its aggregate intent indications are 95 while the aggregate intent indications of the second security is only 70.

In yet another alternative, the buy/sell counts and comments 416 may include the maximum of buy or sell. The maximum of buy is a ranking of the securities based upon the total number of buy intent indications minus the total number of sell intent indications. The maximum of sell is a ranking of the securities based upon the total number of sell intent indications minus the total numbers of buy indications. In effect, these are the securities with the strongest, relative indications of intent to buy or sell respectively. The buy/sell counts and comments 416 in addition to any of the other statistics described herein may be presented to users in the form of a line chart, graph or other visual representation.

In all cases, these statistics are periodically calculated and cached. A user requesting these statistics will be provided with the statistics essentially in real-time because they the periodic calculations preferably occur every few minutes. The pre-calculation and caching enables the social network 310 to provide statistics quickly to users upon request rather than recalculating those statistics each time they are requested.

The next element of the example data structure is the top buyer/seller information 418. This information 418 may include the individuals who most often indicates an intent to buy or sell a stock, those individuals who indicated an intent to buy or sell a stock most recently or those individuals whose intent indications most often accurately reflect changes in the sale price of a security as reflected from a review of historical prices and buy or sell intent indications and the statistics related thereto. Users may be presented with the opportunity to view the profiles and other information associated with a particular top buyer or seller.

The next element of the example data structure for a financial security is the comments 420. These comments 420 may be general comments from users regarding the financial security. These comments may pertain to news events or may include news events related to the financial security or may simply be personal opinions regarding the financial security.

For each financial security, such as the example ABC stock 410 a listing of buyers 422 and of sellers 424 are also stored. These buyers 422 and sellers 424 may be maintained for a set period of time or may be maintained perpetually. The buyers 422 and sellers 424 may be reset, for example, each trading day or on a weekly basis. In these lists, which may be implemented as linked lists, tables, trees or other data format, each user and each user's comments, if any, associated with a financial security are maintained.

User A 426, user B 430 and user N 434 have all indicated an intention to buy the financial security. Data pertaining to each of these buyers 426, 430 and 434 may include various indicia such as other buy and sell intent indications, accuracy ratings, past performance and rankings of activity for each user. In addition, each of these users intent is stored as a member of the buyers 422. Associated with these users are comments, if any, associated with that buy intent indication. User A comments 428 may indicate that the company is doing fabulously as a reason to buy. User B comments 432 may simply be blank, indicating that user B did not make any comments regarding his or her buy intent indication. User N 434, which is intended to represent the last user in a list of buyers 422 of unknown length, also has user N comments 436, indicative of his or her reasons for indicating an intent to buy the stock or any other comment the user desires to make regarding the buy intent indication.

The sellers such as user M 438 who may make comments such as user M comments 440. These comments may relate to the user's reasons for making a sell intent indication. User N 442 also has indicated an intent to sell and may not provide any comments in user N comments 444. User Z 446, which is intended to represent the last user in a list of users of unknown length, may make user Z comments 448 as to his reasons for indicating his or her intent to sell the stock or any other general comments.

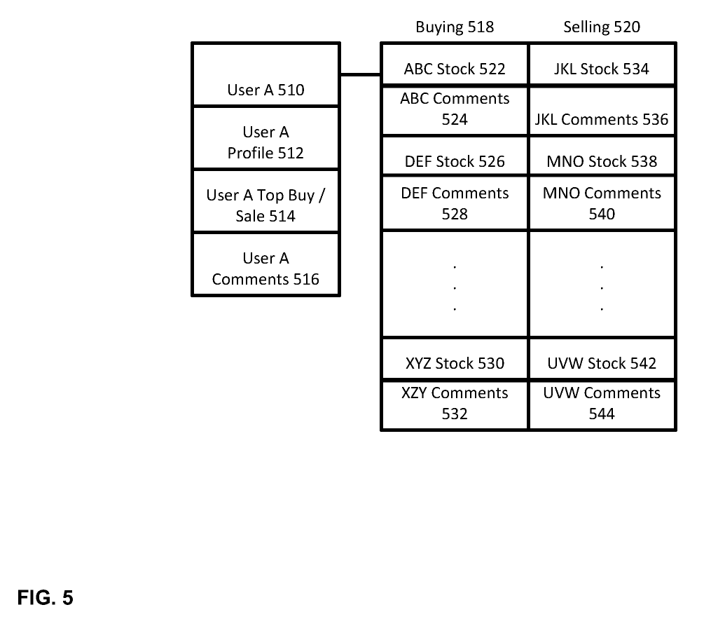

Turning now to FIG. 5, a data structure for the users of the intent indication database is shown. The intent indication database 320 of FIG. 3 may also store user data pertaining to the individual and to the stocks purchased or sold by that individual and the intent indications associated with that individual over time. These intent indications may have an expiration date or maybe maintained indefinitely, as described above.

The user A 510 is an example of a data structure for use with a user. User A 510 may have a username, a password and other indicia of identity. In some cases, user A 510 may have a security credential that enables login and may have an identification other than a username. The user A profile 512 is a profile of the information associated with user A 510. This profile may include a photo, location, links to other websites or social networks, age, income, risk profile, prior buy and sell intent indications and other information that may be relevant to another user of the social network viewing his or her profile. Some or all of this information may be shielded from public view at the request of the user.

The user A top buy/sale 514 may be a listing of the stocks for which user a 510 has indicated an intent to purchase or sell most recently, most often, or most accurately predicting the rise or decline in price (thereby indicating that his or her intent indication to purchase or sell was correct). The accuracy of a user may be provided in terms of a rate of correctness score based upon a user's past ability to predict the movement of a particular security. Users who very often predict movement up or down of a security, based upon their intent indication to buy or sell, will have high rates of correctness. In addition, an activity score may be provided so that users who actively participate in the social network will have higher activity scores than others. Other users can view these statistics.

Different types of correlations may be calculated under the present system. The first two may be presented relative to a particular user. These are the user's accuracy relative to a particular security and the user's accuracy relative to all securities. The second two are correlations for all users. The first is a correlation of all users to a particular security and correlations of all users to all securities. Using the statistics in the intent indication database 320, each of these correlations may be calculated and may be viewable by users of the system. The user A comments 516 may be a list of all general comments made by a user and may include comments made regarding various securities, comments by user A 510 on other users' comments regarding securities or general comments regarding him or herself.

The user A 510 data structure is similar to that of the financial security data structure of FIG. 4. The user A 510 includes a listing of all the stocks that the user a 510 is buying 518 and selling 520. These are lists of stocks for which user A 510 has indicated an intent to buy or sell. For each intent indication, user A 510 includes the name of the security, such as ABC stock 522 and ABC comments 524. The ABC stock 522 is simply an indication of the security that the user A 510 intends to buy. The ABC comments 524 are comments regarding the intent to buy the associated security. In some cases the comments may simply be blank if no comments are given. DEF stock 526 is a second security that user A 510 has indicated an intent to buy. DEF comments 528 are comments associated with that intent indication. Similarly, XYZ stock 530 and XYZ comments 532 pertain to yet another security. Of course, a user may have a list of many, many stocks he or she wishes to buy along with any associated comments.

The data structure associated with users such as user A 510 also includes a selling 520 list. This list is a listing of all securities for which use a 510 has currently indicated an intent to sell. The first security, JKL stock 534 is associated with JKL comments 536 that comment on the reasons for the sale intent indication or include other comments associated with the intent indication. Similar stock identities for MNO stock 538 and similar comments such as MNO comments 540 are provided for each stock in the selling 520 list all the way down to UVW stock 542 and UVW comments 544. These lists of both buying 518 and selling 520 may be any length and include many, many elements.

The user A profile 512 may also be used to access one or more discussion boards email built-into the system or instant and SMS messages. The profile 512 may be associated with these communication means and statistics related to the user may be provided to viewers of the user's comments on the discussion board or as a part of the communication process. Alternatively, someone communicating with user A may be presented with ready access to the user A profile 512 in order to access relevant statistics as an integrated part of the communication process.

The data structure for the financial security shown in FIG. 4 and the data structure for the user shown in FIG. 5 may include elements that overlap and may not, in fact, be implemented separately from one another as shown. All data pertaining to the site may be stored in a unique data structure such that elements include cross-references to one another to allow for easy cross-referencing of users to securities, comments, statistics and intent indications all associated one with another.

Description of Processes

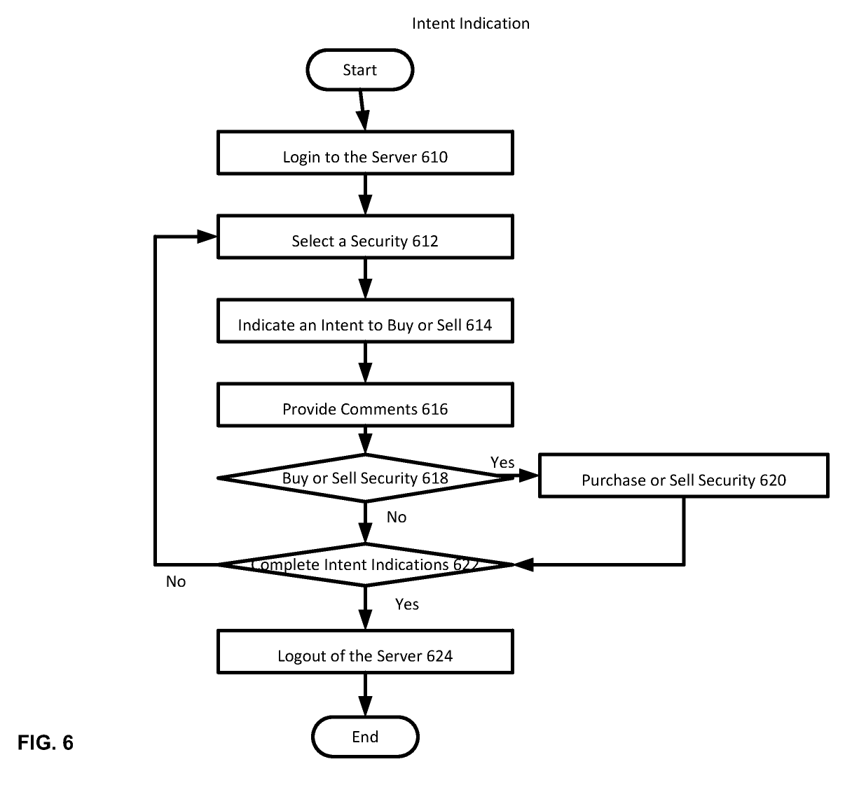

Turning now to FIG. 6 a flowchart of user indication of intent is shown. The user may create an intent indication by first performing a login to the server 610. This may require a new user to first register with the server to create a login password and, in some embodiments, to accept or gain access to a credential of some type.

After a user has logged into the server 610, the user may select a security 612. At this point, the user may utilize web pages provided by the access interface 314 or utilize an input box into which the user may input a ticker symbol or security name in order to be directed to a web page or portion of the software application dedicated to a particular security. A user may click a hyperlink on a webpage either within the access interface 314 or on an unrelated external website. For example, an unrelated external website may have API access to the intent indication database and include links to particular securities and provide means by which a user may input an intent indication for that sock via hyperlink. In that situation, the user may first select a security 612 and then be required to login to the server 610 in order to make an intent indication.

Next, the user is presented with a webpage or the software provides to the user opportunity to indicate an intent to buy or sell 614. This indication may be very formal, for example, requiring a selection and a confirmation of that selection along with the input of identification and credential information. Alternatively, this indication may be very informal, perhaps as simple as clicking a button or hyperlink associated with a purchase or sale indication. At this step, users may, optionally, view the most active securities, the securities with the most buy or sell indications, the securities with the most aggregate buy or sell indications, those that have the highest maximum of buy or maximum of sell, a particular user's intent to buy or sell a security or the accuracy rate of others. After viewing or without viewing, the user may indicate an intent to buy or sell 614.

The user may then provide comments 616 associated with his or her intent indication. As described above, these comments may include reasons why the user has indicated his or her intent to purchase or sell. Alternatively, they may be only somewhat related to the intent indication. Once inputted, the intent indication is stored in the intent indication database 320 along with the user who input it and any comments made by the user associated with the intent indication as described above.

At this point, the user may be presented with an option to buy or sell a security 618, for example, using the buy/sell interface 326 and the electronic broker 328. If the user choose to use the buy/sell interface 326 to purchase or sell a security 620, then the data pertaining to that sale such as the time, purchase price, sale price and whether the purchase or sale was actually completed according to the user's intent indication may be stored in the intent indication database 320 along with the other information pertaining to the user. This information may be useful to others as they determine whether or not to rely upon a particular user's intent indication in the future. If the user chose not to purchase a security or once the purchase is complete, the user may then select another security 612 for which to make an intent indication and begin the process again. If the user has completed all intent indications 622, then the user may logout of the server 624 to end the intent indication session. If the user is not complete, the user may select the same security 12 in order to update his or her intent indication.

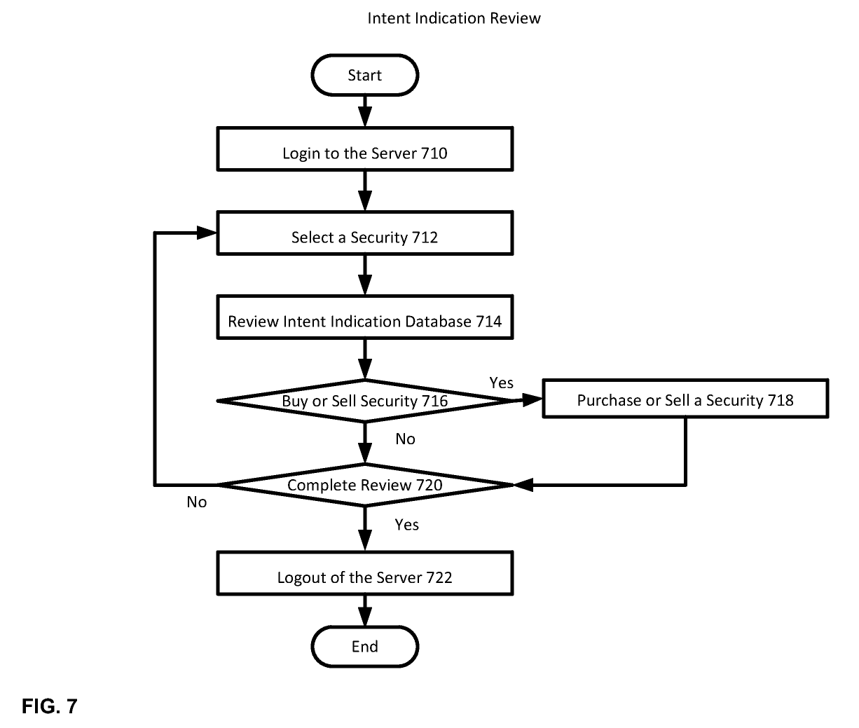

Turning now to FIG. 7, a flowchart of intent indication review is shown. The user first logs into the server 710. This takes place according to the method described above and, if necessary, includes the creation of a username, password or other credentials. Next, the user may select a security 712. As described above, this may be a direct selection by text input of a security ticker symbol, name or other indicia, but may also be by a hyperlink or other form of selection.

The user may then review the intent indication database 714 including a review of the various elements contained in the intent indication database 320 for the selected security. This review process may simply be a review of the total number of users who have indicated an intent to purchase or an intent to sell a given security. Alternatively, it may include a detailed review of all or most of the information in the intent indication database 320 pertaining to the selected security or securities. This may include the current status of the security on the “most buy” or “most sell” list, the statistics related to the historical accuracy of the buy and sell indications for this stock or particular users for whom intent indications have been made. This review may also include a review of the correlation coefficient of a particular user or all users intent indications for a particular security before a decision is made. This information pertaining to the security may be updated in real-time or may updated upon reloading of the associated web page or through a command issued to the software implementing the social network.

The review process may be prompted by user interaction as described above or, alternatively, may be predetermined. A user may indicate a desire to be updated regarding the status of a particular security or securities at predetermined times throughout the day. Alternatively, a user may indicate a desire to be updated regarding the status of a particular security or securities when a threshold is reached. These thresholds, for example, may be total number of intent indications, total buy indications, total sell indications or the status of other statistics related to the security or securities.

The user may be presented with an opportunity to purchase or sell a security 716. At this stage, the user may apply all of the information reviewed from the intent indication database 320 pertaining to the security in order to decide to purchase or sell a security. Once a decision is made to purchase or sell, the user may complete the purchase or sell a security 718 using the buy/sell interface 326 and the electronic broker 328. Alternatively, the user may utilize external means to complete the purchase or sale. If the user utilizes the buy/sell interface 326 and the electronic broker 328, the user's decision and the details of the purchase or sale may be stored in the intent indication database 320 along with the other information pertaining to that user.

If the user is not complete with his or her review 720, then another security may be selected 712. However, if the user is then complete with the review 720, then the user may logout of the server 722, having completed an intent indication review.

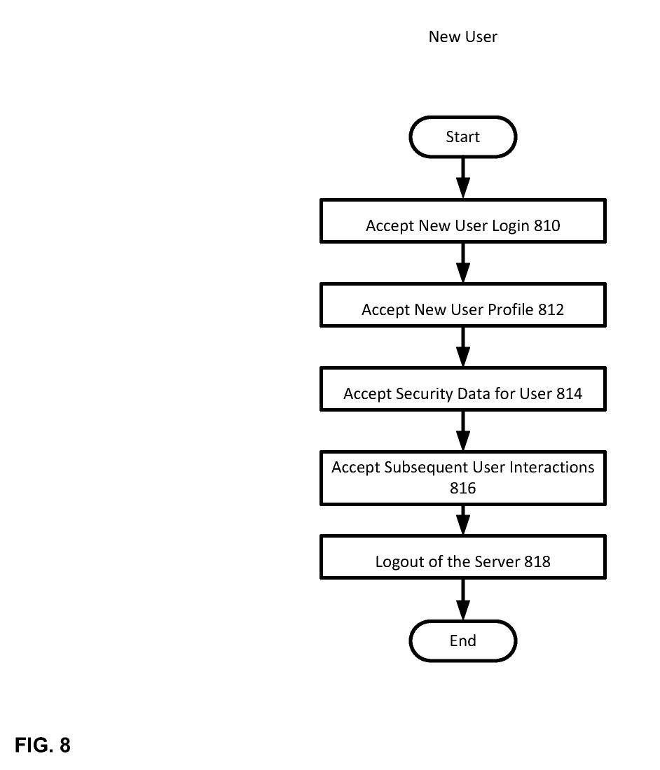

Turning now to FIG. 8 a flowchart of new user acceptance is shown. These steps may be executed by the access interface 314. The access interface 314 first accepts a new user login. The access interface 314 accepts a user's desired username, the input of a password and any additional credential information required for registration. The specific elements required by the access interface 314 may vary from implementation to implementation.

Next, the access interface 314 accepts a new user profile 812. This means that the access interface 314 accepts information pertaining to the user such as his or her name, location, stock holdings, risk profile and any other information that may be requested that is provided by the user. The access interface 314 may also accept security data from a user 814. This may include data pertaining to securities that the individual would like to buy or sell or may include current holdings or past holdings. This may also include comments regarding particular stocks. The information provided may vary from implementation to implementation.

The access interface 314 then may accept subsequent user interactions. These interactions may include subsequent buy or sell intent indications, comments, updated profile information, updated security data, access to the buy/sell interface 326 or other interactions from the user to the server. Finally, the user may logout of the server 818 thus ending the user and server interactions for the time being.

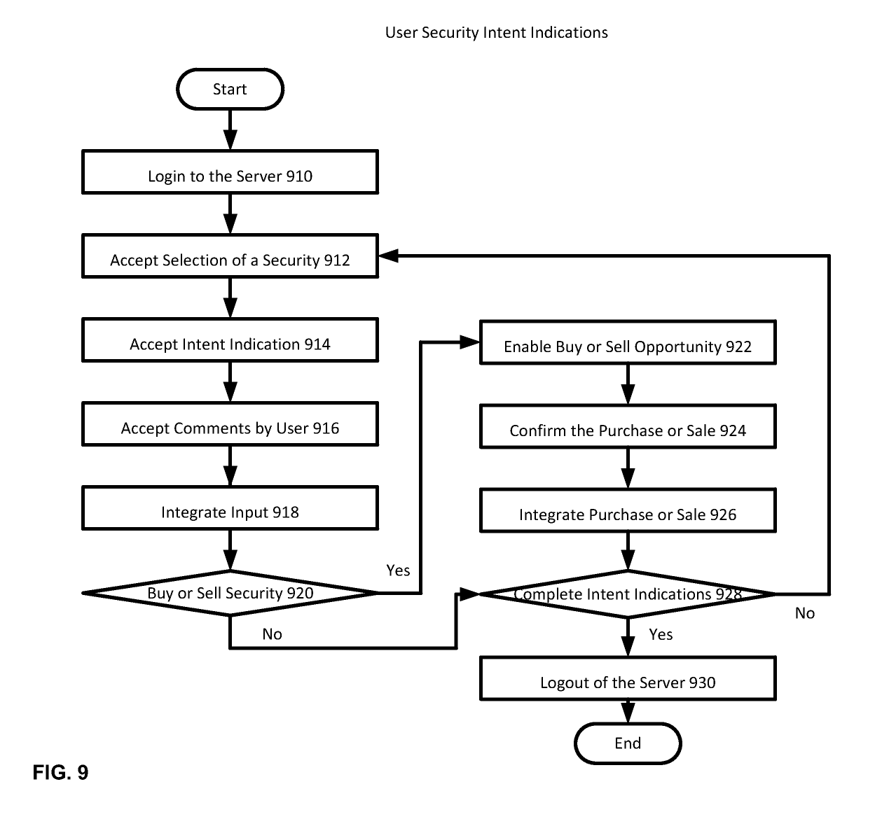

Turning now to FIG. 9, a flowchart of server intent indication acceptance is shown. This process begins with a login to the server 910 by a user who has previously registered. If the user has not previously registered, the user may be registered before proceeding. The access interface 314 may then accept a user selection of a security 912. This selection may take any of the forms previously described. For purposes of this example, a user may input a ticker symbol for a particular security. Alternatively, the user may input a company name, a mutual fund management company or other indicia of the intended security.

After a security is selected, the web page provided by the access interface 314 or the software on the user's mobile or client device prompts a user to input an intent indication regarding the security. The access interface 314 operating on a server 124 accepts the intent indication to purchase or sell a security that is made by a user. This intent indication may also include comments related to the security or the intent indication. The access interface 314 accepts the comments made by the user 916.

The intent indication and comments are then integrated 918 into the intent indication database 320. At this point, the intent indication is added to an aggregate intent indication for the selected security in the intent indication database 320. This aggregation takes place dynamically in real-time. A user may change his or her intent indication at will. As this occurs, that user's intent indication is updated along with the security's aggregate data. A user reviewing the information pertaining to a particular security may be immediately presented with the updated data.

Over time, statistics such as correlation coefficients, regressions and other indicia of the relatedness of historical aggregate intent indications may be created. Historical statistics regarding an individual user's accuracy of intent indications may also be calculated. These statistics may also be reviewed by a user as he or she is determining whether or not to purchase or sell a security in view of the present aggregate intent indication. The intent indication and comments are also integrated into the database for archiving so that historical intent indications for individuals and in aggregate may be retained for statistical purposes.

The user may then be presented with the option to purchase or sell the security 920 for which he or she just indicated an intention to purchase or sell. If the user chooses to purchase or sell the security, the social network 310 may enable the buy or sell opportunity by enabling the buy/sell interface 326 using credentials for the electronic broker 328 already stored along with other user information. The user may then use the buy/sell interface 326 and the electronic broker 328 to complete the sale. Information pertaining to the purchase or sale may be stored in the intent indication database 320. This information may be relevant to later viewers of a particular user's profile in order to determine whether or not a particular user acts consistently with his or her intent indications. If so, the access interface 314, acting in conjunction with the buy/sell interface 326 and the user management processor 316 may confirm the purchase or sale 924 and the data pertaining to the purchase or sale before it is stored in the intent indication database 320.

Once confirmed, the purchase or sale data may be integrated 924 into the intent indication database 320. In particular, this information may be saved to a user's profile and used to calculate correlations between intent indications and actions taken along with, potentially, correlations between intent indications, actions taken and subsequent changes in price. In this way, a determination of the user's intent indications and their reliability and relevance to the market may be made. Once this process is complete or if the user has chosen not to buy or sell a security, the access interface 314 may be used to indicate whether or not the intent indication process is complete 928. If so, the access interface 314 may be used to logout of the server 930. If not, an additional security (or the same security) may be selected 912 and the process repeated. If a user selects the same security, the user may update his or her intent indication in real time.

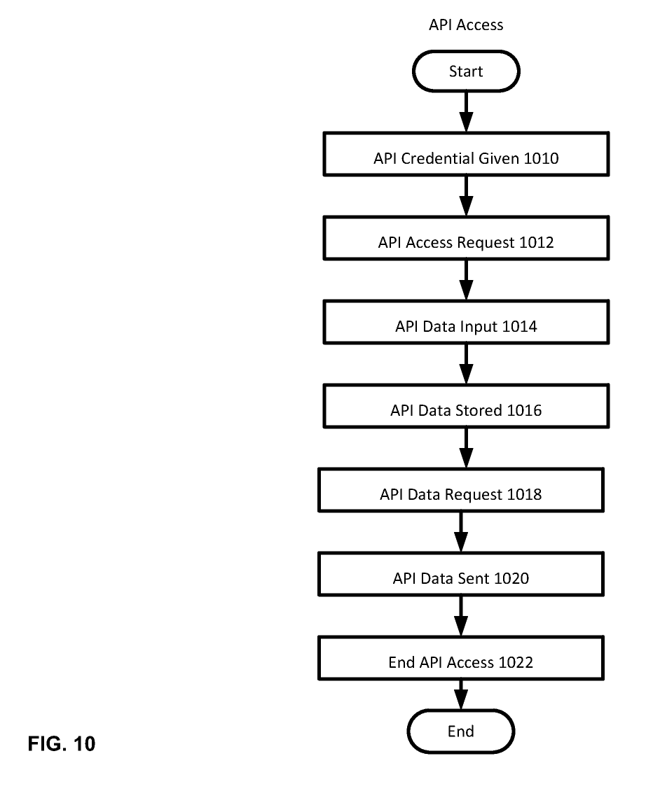

Turning now to FIG. 10, a flowchart of API access is shown. An API credential is given 1010 to an API user (using an API device 330) of the social network 310. This API user may be a third party website, a content aggregator or a third party with large volumes of data to input into the system. In such cases, API access may be the most efficient way for the API user to access or input data for the social network 310. An API credential may be a username and password associated with a particular use that provides special access to input and request data from the API access interface 324. Alternatively, it may merely be a unique individual identifier in conjunction with a particular IP address or other location identifier whereby the API access interface can determine that the API user has been granted API access to the social network 310 and to the intent indication database 320. The credential is some means by which the social network 310 is able to uniquely recognize the API user or API device 330.

The API device 330 may then make an API access request 1012. This request may begin with an opening string of characters or a username and password or other credential that is designed to identify the API device 330 to the API access interface 324. In one implementation, the API access credential is a string of numerals and/or characters immediately preceding an API data input or API data request in conjunction with the IP address of the requesting computer.

The API device 330 may then make a request for API data input 1014 in which the API device 330 interfaces with the API access interface to input one or more elements of data into the intent indication database 320. The API device 330 is familiar with the formatting required by the intent indication database 320 and provides the data in a form suitable or nearly-suitable for immediate addition to or amendment of the intent indication database 320. The API data is then stored 1016 in the intent indication database 320.

Alternatively or in addition, the API device may make an API data request 1018. As with the API data input 1014, this request may be preceded by a credential indicating that the API device 330 is entitled to access to the API access interface 324 and the intent indication database 320. The API data request 1018 may be responded to by sending API data 1020. This data may be raw data in a format identical to or nearly-identical to the format in which the data is stored in the intent indication database 320. After the data is provided, the API access ends 1022. In this way, API access may be provided to users of large amounts of data from the social network 310.

Although aspects of the present application are shown implemented in a personal computer, the processes and apparatus may be implemented with any computing device. A computing device as used herein refers to any device with a processor, memory and a storage device that may execute instructions including, but not limited to, personal computers, server computers, computing tablets, set top boxes, video game systems, personal video recorders, telephones, personal digital assistants (PDAs), portable computers, and laptop computers. These computing devices may run an operating system, including, for example, variations of the Linux, Microsoft Windows, Symbian, and Apple Mac operating systems.

Although some techniques discussed herein are described with regard to a hard disk drive, the techniques may be implemented with storage media in a storage device included with or otherwise coupled or attached to a computing device. That is, the software may be stored in electronic, machine readable media. These storage media include, for example, magnetic media such as hard disks, floppy disks and tape; optical media such as compact disks (CD-ROM and CD-RW) and digital versatile disks (DVD and DVD±RW); flash memory cards; and other storage media. As used herein, a storage device is a device that allows for reading and/or writing to a storage medium. Storage devices include, hard disk drives, DVD drives, flash memory devices, and others.

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A method comprising:
accepting a plurality of intent indications for a financial security, each of the intent indications from one of a plurality of users and each of the intent indications selected from the group consisting of a purchase indication and sale indication;
aggregating the intent indications into an intent indication database including a total of the purchase indications and a total of the sale indications for the financial security; and
providing access to the intent indication database including access to the total of the purchase indications and to the total of the sale indications.

2. The method of claim 1 further comprising executing a trade of the financial security in accordance with one of the intent indications.

3. The method of claim 2 further comprising comparing the one intent indication with the trade to determine whether the one intent indication coincides with the trade.

4. The method of claim 2 further comprising incorporating information pertaining to the trade into the intent indication database.

5. The method of claim 1 wherein each of the intent indications includes data identifying a user who created the intent indication and comments from the user.

6. The method of claim 1 further comprising:
accepting a replacement intent indication for the financial security from the one of the plurality of users, the replacement intent indication being the previously unselected option selected from the group consisting of the purchase indication and the sale indication; and
aggregating the replacement intent indication into the intent indication database; and
providing access to the intent indication database including access to the total of the purchase indications and to the total of the sale indications.

7. The method of claim 1 further comprising generating statistics regarding the accuracy of the one of a plurality of users intent indications relative to prices changes of the financial security.

8. Apparatus comprising a storage medium storing instructions which when executed by a processor will cause the processor to:
accept accepting a plurality of intent indications for a financial security, each of the intent indications from one of a plurality of users and each of the intent indications selected from the group consisting of a purchase indication and sale indication;
aggregate the intent indications into an intent indication database including a total of the purchase indications and a total of the sale indications for the financial security; and
provide access to the intent indication database including access to the total of the purchase indications and to the total of the sale indications.

9. The apparatus of claim 8 wherein the instructions will further cause the processor to execute a trade of the financial security in accordance with one of the intent indications.

10. The apparatus of claim 9 wherein the instructions will further cause the processor to compare the one intent indication with the trade to determine whether the one intent indication coincides with the trade.

11. The apparatus of claim 9 wherein the instructions will further cause the processor to incorporate information pertaining to the trade into the intent indication database.

12. The apparatus of claim 8 wherein each of the intent indications includes data identifying a user who created the intent indication and comments from the user.

13. The apparatus of claim 8 wherein the instructions with further cause the processor to
accept a replacement intent indication for the financial security from the one of the plurality of users, the replacement intent indication being the previously unselected option selected from the group consisting of the purchase indication and the sale indication; and
aggregate the replacement intent indication into the intent indication database; and
provide access to the intent indication database including access to the total of the purchase indications and to the total of the sale indications.

14. The apparatus of claim 8 wherein the instructions with further cause the processor to generate statistics regarding the accuracy of the one of a plurality of users intent indications relative to price changes of the financial security.

15. A system comprising:
an intent indication database to store a plurality of intent indications for a financial security, each of the intent indications from one of a plurality of users and each of the intent indications selected from the group consisting of a purchase indication and sale indication;
an intent indication interface to accept the plurality of intent indications and aggregate the intent indications into an intent indication database including a total of the purchase indications and a total of the sale indications for the financial security; and
an access interface to provide access to the intent indication database including access to the total of the purchase indications and to the total of the sale indications.

16. The system of claim 15 further comprising a buy and sell interface to execute a trade of the financial security in accordance with one of the intent indications.

17. The system of claim 16 wherein the intent indication database incorporates information comparing the one intent indication with the trade to determine whether the one intent indication coincides with the trade.

18. The system of claim 16 wherein the intent indication database incorporates information pertaining to the trade into the intent indication database.

19. The system of claim 15 wherein the intent indication database includes statistics regarding the accuracy of the one of a plurality of users intent indications relative to price changes of the financial security.

20. The system of claim 15 wherein:
the intent indication interface is further to accept a replacement intent indication for the financial security from the one of the plurality of users, the replacement intent indication being the previously unselected option selected from the group consisting of the purchase indication and the sale indication, and to aggregate the replacement intent indication into the intent indication database; and
the access interface is further to and to provide access to the intent indication database including access to the total of the purchase indications and to the total of the sale indications.
